(19) United States
(12) Patent Application Publication
(10) Pub. No.: US 2005/0278341 A1
(43) Pub. Date: Dec. 15, 2005

(54) Component offline deploy

(76) Inventors: Dimitar P. Kostadinov, Sofia (BG); Petio G. Petev, Sofia (BG); Krasimir P. Semerdzhiev, Sofia (BG); Pham D. Quang, Sofia (BG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/856,554

(22) Filed: May 28, 2004

(51) Int. Cl. G06F 7/00

(52) U.S. Cl. 707/10

(57) ABSTRACT

Embodiments include a system for updating software components in a computing system. The update system may deploy software components into a centralized database. The update system may provide an interface for deploying software components into the database. The update system may map the software components into a relational database or similar database system. In an additional embodiment, the deployed software components may be downloaded from the centralized database during a start up process for a computing system.

### BACKGROUND

1. Field of the Invention

The embodiments of the invention relate to software installation applications. Specifically, embodiments of the invention relate to a mechanism to deploy software components to a database where they are downloaded by systems on start up or restart.

2. Background

A cluster system is utilized to provide a set of services and resources to a set of client computers. The cluster system includes a collection of server nodes and other components that are arranged to cooperatively perform computer-implemented tasks, such as providing client computers with access to the set of services and resources. A cluster system may be used in an enterprise software environment to handle a number of tasks in parallel. A cluster system is scalable and has the flexibility to enable additional cluster elements to be incorporated within or added to the existing cluster elements.

The cluster system is a client-server system that employs a multi-tiered architecture. In the multi-tiered system, presentation logic, business logic and a set of services and resources are logically separated from the user interface of the application. A client may execute a user interface. Other layers are moved off of the client to one or more dedicated servers on the network.

A multi-tiered system may be implemented using a variety of different application technologies at each of the layers of the multi-tier system, including those based on the Java 2 Enterprise Edition Specification created by Sun Microsystems, Santa Clara, Calif. (“J2EE”), the Microsoft .NET Framework created by Microsoft Corporation of Redmond, Wash. (“.Net”) and/or the Advanced Business Application Programming (“ABAP”) standard developed by SAP AG. For example, in a J2EE environment, the business layer, which handles the core business logic of the application, is comprised of Enterprise Java Bean (“EJB”) components with support for EJB containers. Within a J2EE environment, the presentation layer is responsible for generating servlets and Java Server Pages (“JSP”) interpretable by different types of browsers at the user interface layer.

The cluster system including its constituent set of components (e.g., resources, services and applications) may be updated or reconfigured by a manual reconfiguration of each application server in the system. Each application server may have new or updated components installed local to the application server. Various applications servers may have differing platforms and attributes (e.g., 32 bit Linux platforms, 64 bit Linux platforms). Each platform and attribute variation of the application server system will have a different installation of components and resources. This requires that an administrator manually load, install and configure new or updated software components at each machine in the system. This task is made more difficult because each machine will have different configuration and software component requirements based on its platform and similar attributes. This process also requires multiple reboots of the machines to update key files and applications such as kernel files, service files, library files and interface files that cannot be updated while the machine is operating. This further requires additional time for the administrator at each machine in the cluster to update or install software components.

### SUMMARY

Embodiments include a system for updating software components in a computing system. The update system may deploy software components into a centralized database. The update system may provide an interface for deploying components into the database. The update system may map the components into a relational database or similar database system. In an additional embodiment, the deployed components may be downloaded from the centralized database during a start up process for a computing system.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a block diagram of one embodiment of an offline deployment system.

FIG. 2 is a flowchart of one embodiment of a process for deploying files into the database system.

FIG. 3 is a flowchart of one embodiment of a process for removing files from the database system.

FIG. 4 is a diagram of one embodiment of a computer system running the deployment system.

FIG. 5 is a diagram of one embodiment of a cluster system running the deployment system.

### DETAILED DESCRIPTION

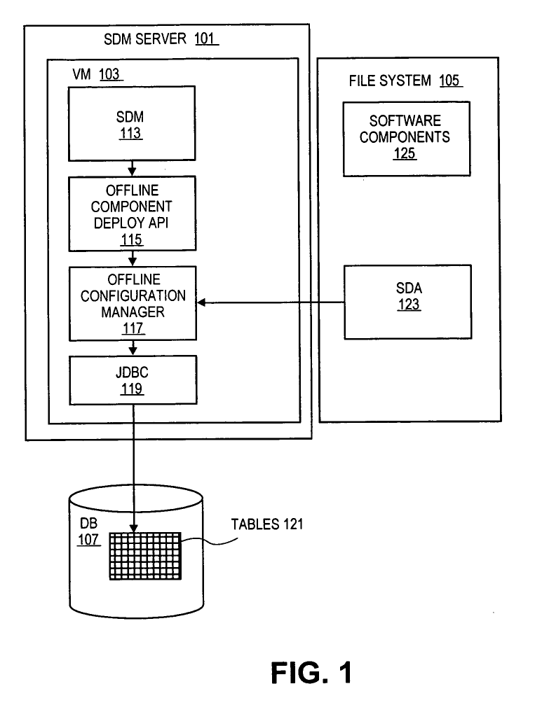

FIG. 1 is a diagram of one embodiment of a computer system utilizing an offline component deployment system. As used herein a “component” may be a set of files, archives and similar data that may form a portion or whole of an application, service or similar program or set of programs. In one embodiment, the deployment system operates on a local machine to update the files of software components, applications and services that are stored in a database 107 in communication with the local machine. In one embodiment, the local machine may provide a software deployment module (SDM) server 101. SDM server 101 may be a server primarily dedicated to updating, deploying and removing components for a cluster. In another embodiment, SDM server 101 may be distributed across multiple machines.

In one embodiment, the SDM server 101 may have access to or be in communication with a file system 105. File system 105 may be used to store components to be deployed to database 107. In one embodiment, file system 105 may also store components 125 related to the applications and services provided by SDM server 101. In one embodiment, components stored by file system 105 may include archive files 123. An archive file is a file that may contain multiple files in a compressed or encrypted format. In one embodiment, an archive file may be a software deployment archive (SDA) containing a set of software components to provide a set of applications or services. As used herein a ‘set’ may be any number of items including one or zero. In one embodiment, an archive file may be a java archive file. A java archive file may be used to store code in class files to be used to instantiate objects in a java virtual machine 103. In another embodiment, other types of archive files may be supported by the deployment system including zip files and similar archive files. In one embodiment, an archive file may store any types of components including binary files, data, text files and similar file types.

In one embodiment, a software deployment archive (SDA) 123 may be an archive file containing a set of components related to a service or set of services, application or similar programs that are to be deployed to a database and ultimately to an application server, dispatcher or similar system. SDA 123 may contain a set of archive files such as java archive files or deployment components that contain code or data for the service, application or other programs being deployed. SDA 123 may also include a set of indicator files providing information about the attributes of the deployment components to be deployed from SDA 123. The identifier files may identify the portions of SDA 123 that are intended for use on designated platforms such as Linux, Windows, and similar platforms. The indicator files may also provide information about the deployment components indicating: whether the components are for use on a server or dispatcher, which character sets are supported, bit lengths of supported platforms, components that are operating system libraries and similar categorizations and data related to the deployment components.

In one embodiment, indicator files may be in a marked-up language such as XML. These indicator files may be verified as fitting defined formats in definition type documents (DTD)s or similarly checked for accuracy. The identifier files may contain information such as version number and similar information about SDA 123 and components in SDA 123.

In one embodiment, SDM server may provide applications and services including deployment system modules using a virtual machine 103 environment. Virtual machine 103 may be a java virtual machine such as a java virtual machine based on the Java 2 Enterprise Edition Specification (“J2EE”) created by Sun Microsystems, Santa Clara, Calif., or similar virtual machine. Virtual machine 103 may support any number of applications and services including a software deployment module 113, offline component deployment application programmer interface (API) 115, offline configuration manager 117 and similar applications, modules, or programs. Other applications, services and similar programs and modules may also be executed by the local machine or SDM server 101 in the form of objects or sets of objects.

In one embodiment, a software deployment module 113 may provide a user interface to allow a user to select a set of software components to be deployed to a database, application server, or similar computer system or platform. The user interface may be a graphical user interface (GUI). The software deployment module 113 may display a list or similar representation of a set of possible components that may be deployed. The software components available for deployment may be stored in local file system 105 or in any storage location accessible to the software deployment module 113. Software deployment module 113 may search for or detect software components that may be deployed. In one embodiment, the software deployment module 113 may also be utilized to remove software components from a database or target system. Software deployment module 113 may access an index, list or similar data structure to determine which components are present in the database. The user may then select the set of components that are desired to be removed. In another embodiment, a software deployment module user interface may be provided by a remote machine from SDM server 101.

In one embodiment, software deployment module 113, may utilize an offline component deployment API 115 to initiate a deployment or removal operation. Offline component deployment API 115 may provide a set of deploy methods, routines or programs to be utilized by software deployment module 113 or similar applications. Offline component deployment API 115 may also provide a set of remove methods, routines or programs to be utilized by software deployment module 113. The varying methods, routines or programs provided by offline component deployment API 115 allow for a varying set of parameters to be utilized or set. The parameters may include target database, component attributes, component names, component locations and similar data and information related to the components to be deployed or removed or related to the database or file system the components are to be deployed to or removed from. The methods, programs and routines of offline component deployment API 115 generate a mapping of the file structure of the components and resources to be deployed or removed. In one embodiment, the data to be placed in database 107 is structured as an SDA 123. SDA may include indicator files that may be used by offline component deploy API 115 to determine the file structure mapping of components to be deployed or removed.

In one embodiment, an offline configuration manager 117 handles the further organization of the deployment or removal procedure by mapping the file structure provided by offline component deployment API 115 into a table structure of a database. Offline configuration manager 117 may generate a standardized query to effect the desired deployment or removal procedure representing the mapping of the file structure into the tables of the database. For example, the generation of the standardized query may map components or similar data of a deployment into a set of tables 121 in database 107. Alternatively, for a removal procedure, a similar mapping of a file structure of components to be removed from tables in database 107 may be used to generate the proper standardized query 123 to effect the removal.

In one embodiment, the query generated by the offline configuration manager 117 may be converted into a native query by a database driver 119. In one embodiment, a java database connectivity driver 119 may be utilized to communicate with database 107. The database driver may carry out the desired transfer of data into the database or the desired removal of data from the database. For example, java database connectivity driver (JDBC) 119 may transfer the contents of SDA 123 from a local file system 105 to database 107. In another embodiment, offline configuration manager 117 may initially generate a native query for deployment and removal operations. In a further embodiment, an SQL translation module may transform a standardized SQL query from offline configuration manager 117 into a SQL query for a specific database such as Oracle database systems, Mirosoft SQL Server, IBM database systems (DB2), SAP database systems (SAP DB), and similar database systems. The SQL translation module may be an Open SQL module.

In one embodiment, the deployment system including the software deployment module 113, offline component deployment API 115, offline configuration manager 117 and database connectivity driver 119, may be in communication with database 107. Database 107 may be a local database or a remote database. Database 107 may be stored on a fixed disk, removable media or similar storage media. Database 107 may store a set of components to be deployed to a machine and file systems in a cluster or in communication with database 107.

In one embodiment, the offline component deployment system may be utilized to deploy services, applications and programs that cannot be updated during the operation of a target system. For example, primary interfaces, primary libraries, primary services, an engine kernel or engine bootstrap program or similar services, applications or programs may not be updated during operation of the computer system. The offline deployment system may modify the configuration of these application and services or install these types of applications and services to a database. The database may then be accessed by a target machine such as an application server, dispatcher or similar machine during system startup, restart or similar time period to update the services, applications or programs on the target machine. These services and applications may be packaged in an SDA of varying types such as a primary interface SDA, primary library SDA, primary service SDA, engine kernel SDA, engine bootstrap SDA or similar SDA, where each SDA type may contain indicator files describing attributes of the contained files and overall SDA pertinent to the type of SDA.

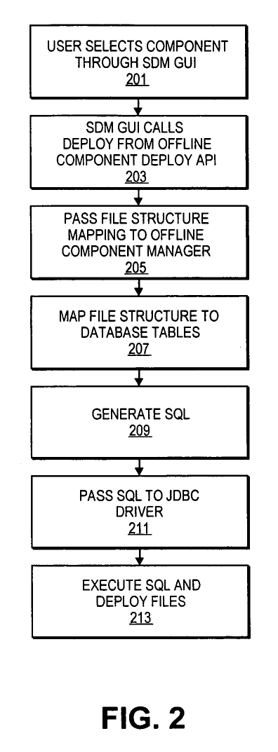

FIG. 2 is a flowchart of one embodiment of a process for deploying a set of software components and content components to a database. In one embodiment, the process of deploying the software components and content components may be initiated by a user selecting a set of components or similar data to be deployed using a graphical user interface or other type of user interface (block 201). The graphical user interface may be part of a software deployment manager. The software deployment manager may provide a user with a set of possible components or similar data that may be deployed to the database. In one embodiment, the set of components may be a part of an SDA or set of SDA's. In one embodiment, the SDAs contain a set of java archive files or similar components to be deployed.

In one embodiment, the software deployment manager calls, invokes or similarly passes arguments to an offline component deployment API to deploy the selected components or similar data (block 203). The offline component deployment API may provide a set of methods, routines or similar programs to facilitate the deployment of components to the database. In one embodiment, the offline component deployment API may provide a set of ‘deploy’ methods that take different sets of arguments. The arguments may include component file names to be deployed, archive names, component locations or providers, component or program types, database locations and similar parameters. The offline component deployment. API may be used to provide a standardized interface for initiating a deployment of software components or similar data. The offline component deployment API maps the file structure of the component or resources to be deployed or removed and passes this mapping to the offline configuration manager (block 205). The arguments or data passed by the offline deployment API to the offline configuration manager may be a mapping of an SDA to a file system structure for the components to be deployed. A set of attributes for the components to be deployed may also be passed to the offline component manager.

In one embodiment, the offline configuration manager may be an object, routine or similar program that is responsible for determining how the components are to be deployed in the database. The offline configuration manager may map the components in the form of a file structure created by the offline component deploy API into the database. The database may be a relational database. The database may be structured as a set of tables or similar data structures. The offline configuration manager may map the components in the form of the file structure map into the table structure of the database (block 207). Components may be designed for multiplatform support and may contain native libraries for multiple platforms. There may be a description file in the database that corresponds to a component to be deployed that provides a mapping of platforms to native libraries.

In one embodiment, the offline configuration manager may generate a set of commands or queries to manage the transfer of the components into the database (block 209). The commands may be generated in a standard structured query language (SQL). The commands may direct the insertion of the components into the database. In one embodiment, these commands may be passed to a database connectivity driver to communicate them to the database (block 211). For example the connectivity driver may be a java database connectivity (JDBC) driver or similar program. The connectivity driver may translate the general commands received into a set of commands native to the target database. For example, if the database is an Oracle database the commands may be translated into SQL commands utilizing the format and commands recognized by the Oracle database. In another embodiment, an Open SQL module may be used to transform general SQL queries into database specific queries. The commands may then be executed to effect the transfer or copying of the components from a file system accessible to the deployment system into the database (block 213). The components may be transferred to the database using any communications medium or protocol.

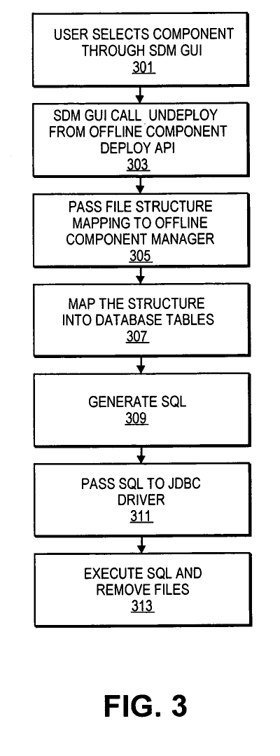

FIG. 3 is a flowchart of one embodiment of a process for removing a set of components from a database. In one embodiment, the process of removing the components may be initiated by a user selecting a set of components or similar data to be removed or ‘undeployed’ using a graphical user interface or other type of user interface (block 301). ‘Undeployed’, software components or similar data may not be deleted from the database. The undeployed data may be designated as undeployed and may subsequently be removed from a system utilizing the database as a guide for updating the system. The graphical user interface may be part of a software deployment manager. The software deployment manager may provide a user with a set of possible components or similar data that are in the database that may be removed or undeployed. In one embodiment, the set of components may be a software deployment archive or set of software deployment archives. In one embodiment, the components to be removed or undeployed may be or contain java archive files.

In one embodiment, the software deployment manager calls, invokes or similarly passes arguments to an offline component deployment API to undeploy or remove the selected components or similar data (block 303). The offline deployment API may provide a set of methods, routines or similar programs to facilitate the removal or undeployment components from the database. In one embodiment, the offline component deployment API may provide a set of ‘undeploy’ methods that take different sets of arguments. The arguments may include component file names to be undeployed, component locations or providers, component types, database locations and similar parameters. The offline component deployment API may be used to provide a standardized interface for initiating an undeployment of a component or similar data. The offline component deployment API determines a file structure mapping for the components to be undeployed. The file structure mapping may include identifying dependent files not explicitly designated for removal or undeployment. In one embodiment, the offline component deployment API may pass file structure mapping to an offline configuration manager (block 305). The arguments or data passed by the offline component deployment API to the offline configuration manager may be a file structure mapping of components to be undeployed or removed and a set of attributes for the components to be undeployed or removed.

In one embodiment, during the designation of components to be removed or undeployed from the database a check may be made to determine the number of shared resources or files such as native libraries that utilize or rely on each component or related components. In one embodiment, this check is made by the SDM. If a shared resource is detected that no components utilize due to their removal or undeployment, then the shared resources which are not referenced or relied on by components may be removed or undeployed for a platform or configuration. For example, a set of components related to an application may be designated by a client for removal. During the undeployment operation, the offline deployment system may determine that a library file that had been utilized by the application is no longer needed and add it to the components to be undeployed.

In one embodiment, the offline configuration manager may be an object, routine or similar program that maps the file structure of components to be undeployed or removed into the table structure of the database (block 307). In one embodiment, the offline configuration manager may generate a set of commands or queries to manage the removal or undeployment of the programs, files, components or archives from the database (block 309). The commands may be generated in SQL. The commands may direct the removal or marking of the component as undeployed in the database. In one embodiment, these commands may be passed to a database connectivity driver to communicate them to the database (block 311). For example the connectivity driver may be a JDBC driver or similar program. The connectivity driver may translate the general commands received into a set of commands native to the target database. For example, if the database is an Oracle database the commands may be translated into SQL commands utilizing the format and commands recognized by the Oracle database. In another embodiment, an Open SQL module or similar application may translate standard SQL statements into database specific instructions or queries. The commands may then be executed to effect the removal or marking of the components in the database (block 313). Components may be marked to indicate undeployment. The queries and commands may be transferred to the database using any communications medium or protocol.

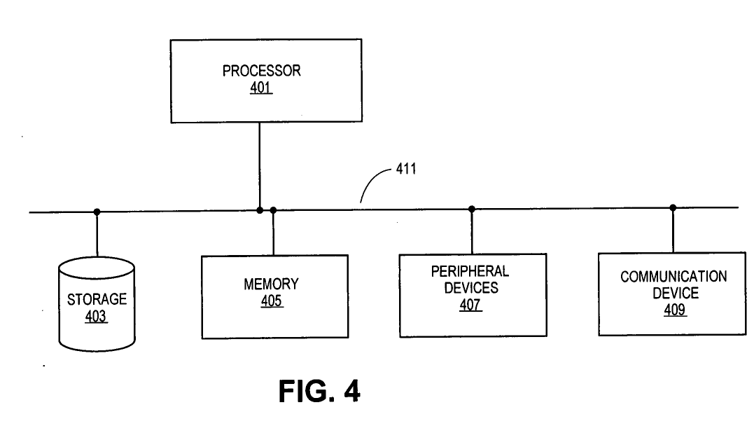

FIG. 4 is a block diagram of an exemplary computer system for executing the offline deployment system. In one embodiment, the computer system may include a processor 401 or set of processors to execute the offline deployment system modules, virtual machine, applications, services and similar programs. The processor may be a general purpose processor, application specific integrated circuit (ASIC) or similar processor. Processor 401 may be in communication via a bus 411 or similar communication medium with a memory device 405. Memory device 405 may be a system memory device or set of devices such as double data rate (DDR) memory modules, synchronized dynamic random access memory (SDRAM) memory modules, flash memory modules, or similar memory devices. Memory device 405 may be utilized by processor 401 as a working memory to execute the virtual machine, applications, the offline deployment system and similar programs.

In one embodiment, the computer system may include a storage device 403. Storage device 403 may be a magnetic disk, optical storage medium, flash memory, or similar storage device. Storage device 403 may be utilized to store a file system, components, including offline deployment modules, temporary files, index files and similar components and data structures. The computer system may also include a set of peripheral devices 407. Peripheral devices 407 may include input devices, sound system devices, graphics devices, display devices, auxiliary storage devices, or similar devices or systems utilized with a computer system.

In one embodiment, the computer system may include a communication device 409. Communication device 409 may be a networking device to allow the computer system and applications, services and similar programs to communicate with other computers, applications, services and similar programs. In one embodiment, communication device 409 may be utilized to communicate with a remote database and send or transfer files to the database.

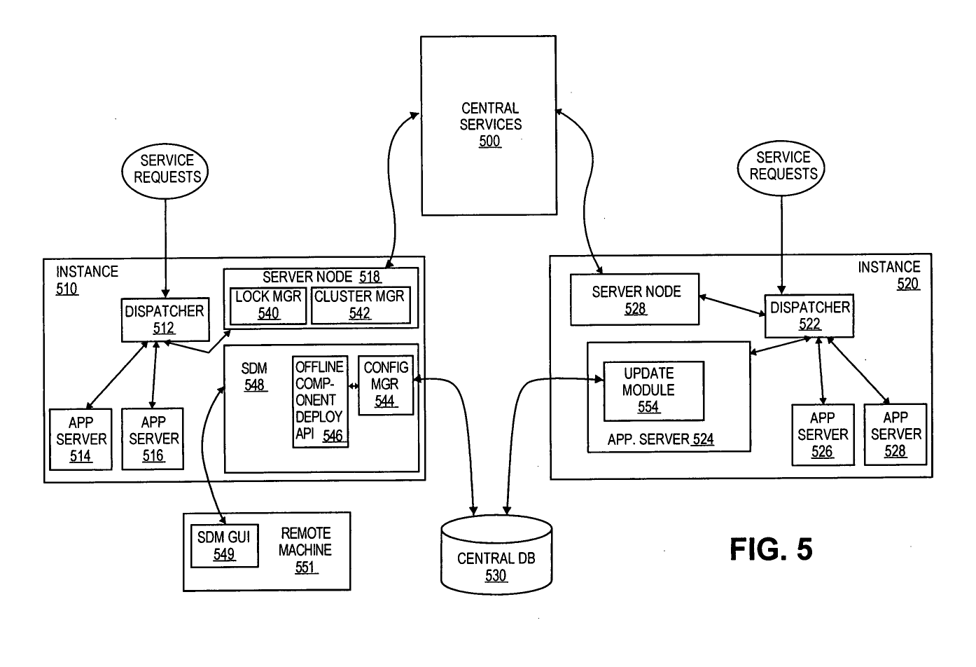

FIG. 5 is one embodiment of a cluster system that includes an offline component deployment system. In one embodiment, the system may include a central services instance 500 and a plurality of application server instances 510, 520. In one embodiment, the application servers are organized into groups referred to as “instances.” Each instance includes a group of redundant application servers and a dispatcher for distributing service requests to each of the application servers. A group of instances may be organized as a “cluster.” The application server instances, 510 and 520, may each include a group of application servers 514, 516, and 524, 526, 528 respectively, and a dispatcher, 512, 522, respectively. Central services instance 500 may include a set of services for use by applications and machines in the cluster such as locking services, messaging services, and similar services. The combination of the application server instances 510, 520 and the central services instance 500 may be the primary constituents of the cluster system. Although the following description will focus primarily on instance 510 for the purpose of explanation, the same principles and concepts apply to other instances such as instance 520.

In one embodiment, the application servers 514 and 516 within instance 510 may provide business and/or presentation logic for the network applications supported by the cluster system. Each of application servers 514 and 516 within a particular instance 510 may be configured with a redundant set of application logic and associated data. In one embodiment, dispatcher 512 distributes service requests from clients to one or more of application servers 514 and 516 based on the load on each of the servers.

In one embodiment, the cluster may include a software deployment module (SDM) Server 548 and a server node 518. Server node 518 may coordinate central services for instance 510. For example, server node 518 may provide access to locking services via a lock messenger 540 and messaging services through cluster manager 542. In one embodiment, instance 510 may include a SDM server 548 including offline component deployment API module 546 and offline configuration manager 544. SDM 548 may provide an interface for a client to determine a set of components to be deployed, removed or undeployed from database 530. SDM 548 may utilize methods, routines, functions or similar programs from offline component deployment API 546 to effect the deployment, removal or undeployment of the designated components. Configuration manager 544 may further facilitate the communication and utilization of database 530 and generate a set of instructions or commands to be executed by database 530 to remove, undeploy or deploy designated components. SDM 548, offline component deployment API 546 and offline configuration manager 544 may be located in any instance in communication with database 530. In another embodiment, a SDM GUI 549 may be provided on a machine 551 remote from instance 510 or SDM server 548.

In one embodiment, servers 514, 516, 518, and 548 may be Java 2 Enterprise Edition (“J2EE”) servers which support Enterprise Java Bean (“EJB”) components and EJB containers (at the business layer) and Servlets and Java Server Pages (“JSP”) (at the presentation layer). In another embodiment, the cluster system, applications servers and SDM servers may be implemented in the context of various other software platforms including, by way of example, Microsoft NET platforms and/or the Advanced Business Application Programming (“ABAP”) platforms developed by SAP AG.

In one embodiment, a second instance 520 may include a dispatcher 522, application servers 524, 526 and 528 as well as a server node 528 for central services related service similar to server node 518. In one embodiment, update module 554 may communicate with database 530 to update each application server or similar resource in accordance with a configuration of components deployed in database 530. In one embodiment, database 530 may contain components to be deployed to an array of different platforms. Updating an application server in accordance with a deployment on database 530 may include removing or undeploying components from the application server that are no longer a part of the deployment present on database 530. Each application server may have an update module in communication with database 530. Application servers in each instance may have update modules. In another embodiment, each instance may have an update module.

In one embodiment, update module 554 may utilize only the components that are designated for deployment on the platform of the application server associated with update module 554. For example, some cluster or application servers may operate on a Windows platform, while other clusters or application servers may operate on a Linux platform. The database may include file descriptors, tables or similar structures to identify which components are to be deployed to each platform or to platforms with specific properties (e.g., 64-bit or 32-bit platforms).

In one embodiment, the offline deployment system may be implemented in software and stored or transmitted in a machine-readable medium. As used herein, a machine-readable medium is a medium that can store or transmit data such as a fixed disk, physical disk, optical disk, CDROM, DVD, floppy disk, magnetic disk, wireless device, infrared device, and similar storage and transmission technologies.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. A apparatus comprising:
an interface to select a software component for one of deployment and removal;
a database to store software components for use by a server to provide services to a client; and
a deployment module in communication with the interface and a database to provide a standardized interface to initiate one of a deployment and a removal of a software component from the database.

2. The apparatus of claim 1, wherein the deployment module generates a mapping of a file structure of a component to be one of deployed and removed.

3. The apparatus of claim 1, further comprising:
a configuration manager to generate a set of database commands to implement the removal or deployment of the software component.

4. The apparatus of claim 1, further comprising:
a software deployment archive containing the software component.

5. The apparatus of claim 1, further comprising:
a server in communication with the database to update its configuration based on the deployment in the database.

6. A method comprising:
receiving a deployment request;
accessing a software deployment archive; and
initiating a transfer of a software components in the software deployment archive into a database, the database to supply a set of servers with the software component.

7. The method of claim 6, wherein accessing comprises:
opening the software deployment archive (SDA) which is one of a bootstrap SDA, a kernal SDA, service SDA, library SDA, interface SDA, single module SDA, and java application SDA.

8. The method of claim 6, further comprising:
analyzing a software deployment archive to validate files in the software deployment archive.

9. The method of claim 6, further comprising:
mapping the software component into the database which is a relational database.

10. The method of claim 6, further comprising:
opening a java archive file containing the software deployment archive.

11. The method of claim 6, further comprising:
replacing the software component in the database with an updated software component.

12. A method comprising:
receiving an indicator of a software component;
receiving a remove request; and
initiating the removal of the software component from a database, the database to supply a set of servers with software components.

13. The method of claim 12, further comprising:
tracking references to a software component and removing the software component if no references exist.

14. The method of claim 12, further comprising:
sending a query to the database which is a relational database that contains software components for applications.

15. The method of claim 12, further comprising:
determining a location of the software component in the database.

16. A system comprising:
a client;
a plurality of servers to provide a service to the client;
a central database to provide a software component of the service to each of the plurality of servers; and
a deployment module to deploy or remove the software component from the central database.

17. The system of claim 16, further comprising:
a user interface to allow a selection of the software component to be deployed or removed.

18. The system of claim 16, further comprising:
a configuration manager to map a software component into a relational database location.

19. An apparatus comprising:
means for receiving a command to deploy a software deployment archive; and
means for transferring the software deployment archive to a database, the database to supply a software component to a server to provide a service.

20. The apparatus of claim 18, further comprising:
means for opening the software deployment archive (SDA) which is one of a bootstrap SDA, a kernal SDA, a service SDA, a library SDA, an interface SDA, a single module SDA, and a java application SDA.

21. The apparatus of claim 18, further comprising:
means for replacing a set of files in the database with files from the software deployment archive.

22. An apparatus comprising:
means for receiving a command to remove a software component from a database, the database providing the software component to a set of servers to provide a service; and
means for removing the software component from the database.

23. The apparatus of claim 21, further comprising:
means for tracking references to a resource and initiating a removal of the resource if no references to the resource exist.

24. The apparatus of claim 22, further comprising:
means for locating the software component in the database.

25. A machine readable medium, having instructions stored therein which when executed cause a machine to perform a set of operation comprising:
receiving a command to deploy a software deployment archive; and
transferring the software deployment archive to a database, the database to supply a software component to a server to provide a service.

26. The machine readable medium of claim 25, having further instructions stored therein which when executed cause a machine to perform a set of operations further comprising:
opening the software deployment archive (SDA) which is one of a bootstrap SDA, a kernal SDA, a service SDA, a library SDA, an interface SDA, a single module SDA, and a java application SDA.

27. The machine readable medium of claim 25, having further instructions stored therein which when executed cause a machine to perform a set of operations further comprising:
replacing a set of files in the database with files from the software deployment archive.

28. A machine readable medium, having instructions stored therein which when executed cause a machine to perform a set of operation comprising:
receiving a command to remove a software component from a database, the database providing the software component to a set of servers to provide a service; and
removing the software component from the database.

29. The machine readable medium of claim 28, having instructions stored therein which if executed cause a machine to perform a set of operation comprising:
tracking references to a software resource and initiating a removal of the software resource when no references to the software resource exist.

30. The machine readable medium of claim 28, having further instructions stored therein which when executed cause a machine to perform a set of operations further comprising:
locating the software component in the database.
